(19) United States
(12) Patent Application Publication
(10) Pub. No.: US 2022/0103420 A1
(43) Pub. Date: Mar. 31, 2022

(54) NETWORK MANAGEMENT METHOD, NETWORK SYSTEM, AGGREGATED ANALYSIS APPARATUS, TERMINAL APPARATUS AND PROGRAM

(71) Applicant: NEC Corporation, Tokyo (JP)

(72) Inventors: Takashi SASAKI, Tokyo (JP); Kazushi KUBOTA, Tokyo (JP); Mamoru TAKAJO, Tokyo (JP)

(21) Appl. No.: 17/434,812

(22) PCT Filed: Feb. 28, 2020
(86) PCT No.: PCT/JP2020/008454

§ 371 Date: Aug. 30, 2021

(30) Foreign Application Priority Data
Mar. 1, 2019 (JP) 2019-037194

(51) Int. Cl. H04L 41/0659; H04L 41/16; H04L 43/0852; H04L 43/0811; H04L 43/0829

(52) U.S. Cl. CPC H04L 41/0659; H04L 41/16; H04L 43/0829; H04L 43/0811; H04L 43/0852

(57) ABSTRACT

An aggregated analysis apparatus receives, from one or more terminal apparatuses connecting to a network, path information from an individual terminal apparatus to a destination node, acquired by the individual terminal apparatus, and isolates, by using a learning model, a suspected failure location on the network based on the path information.

### REFERENCE TO RELATED APPLICATION

This application is a National Stage Entry of PCT/JP2020/008454 filed on Feb. 28, 2020, which claims priority from Japanese Patent Application 2019-037194 filed on Mar. 1, 2019, the contents of all of which are incorporated herein by reference, in their entirety.

### FIELD

The present invention relates to a network management method, a network system, an aggregated analysis apparatus, a terminal apparatus and a non-transitory medium storing a program.

### BACKGROUND

A network, which is utilized, in an enterprise or the like, for business activities and so forth, has been no longer limited to use within an enterprise due to progress in services and devices. For example, there is a case where an external terminal accesses an enterprise internal server by using a radio access network, a core network, or the like of a communication carrier, and a case where a terminal, from an enterprise internal LAN (Local Area Network) or the like, utilizes an external cloud service and so forth. In a case where a malfunction occurs in communication between a terminal and a destination thereof due to a network congestion, failure or the like, an analysis is executed for a network appliance(s) on a side of a communication carrier, a network appliance(s) in the enterprise internal LAN, a communication service and so forth. This analysis operation may require increased man-hours and resources, and further skills, depending on a scale of a network and the number of components thereof.

Regarding the analysis on a network failure, for example, PTL (Patent Literature) 1 discloses the following problems. That is, in a case where data transmitted from a certain apparatus to another apparatus as a destination does not reach there, the apparatus that has transmitted the data can detect an error. However, a system administrator identifies a location of a failure in a communication path from the apparatus that has transmitted the data to a destination apparatus, that is, a location of an actual failure, and failure analysis takes too much time. The larger is a scale of a system, the more difficult is identification of a failure occurrence location (suspected fault location). Therefore, bloated time required for the failure analysis becomes a problem. In PTL 1, to address this problem, the followings are disclosed as a network monitoring method for detecting a location of failure occurrence on a network. A communication state monitoring means monitors a communication status with other device(s) on the network, and an anomaly detection means detects an event indicating an anomaly from communication contents detected by the communication status monitoring means. A failure location determination means, by referencing to a failure location determination table in which elements, each being a possible cause of occurrence of a failure on the network are classified in advance and an event indicating an anomaly in communication via the network is associated with the element classified, determines an element which is an occurrence cause of an event detected by the anomaly detection means. A failure information output means outputs failure information indicating a determination result by the failure location determination means.

Regarding AI (Artificial Intelligence) based failure analysis, PTL 2 discloses a problem that, in a case of a single failure, a processing speed is not regarded as so problematic in an existing expert system, when a plurality of failures are notified asynchronously, it is almost impossible to present an inference result with high reliability in a short time period, and in a case of occurrence of lack knowledge or a system error, the system would stop processing for a long period or would result in complete no function. To address this problem, PTL 2 discloses a communication network failure management system having excellent distributed processing capability and real-time processing performance and capable of being configured more flexibly and easy for maintenance. This system includes a rule-based inference autonomous agent and a memory-based inference autonomous agent and includes a primary isolation autonomous agent group that analyzes an event notified from an event recognition autonomous agent group and determines a failure cause or a failure location.

NPL (Non-Patent Literature) 1 discloses a network anomaly detection technology and an automatic failure location inference technology utilizing AE (Auto Encoder) (that has been subjected to supervised learning using the same data in an input layer and an output layer in 3-layers neural network), which is one type of deep learning capable of realizing learning of complicated structure inherently present in data.

PTL 1: Japanese Unexamined Patent Application Publication NoJP2005-167347A

PTL 2: Japanese Unexamined Patent Application Publication No JP Hei 09-160849A

NPTL 1: Keishiro WATANABE, et. al., “Creation of new value by utilizing Network-AI technology”, NTT journal, 2018 Vol. 30, No. 3, searched on Feb. 5, 2019, internet <URL: http://www.ntt.co.jp/journal/1803/files/JN20180313.pdf>

### SUMMARY

An analysis on the related technologies is provided as follows.

In PTL 1, the communication status monitoring means monitors a communication status with another apparatus on a network, and obtains a packet exchanged between a communication means and a communication interface to analyze content of the packet. PTL 1 discloses that, for example, the communication status may be monitored for each connection, but does not disclose a configuration where a failure analysis on the network is executed based on path information between with a destination. The same is applied to PTL 2 and NPTL 1.

It is an object of the present invention to provide a network management method, a network system, apparatuses, a non-transitory medium storing a program, each enabling to appropriately narrow down a suspected failure location on a network, thereby enabling to perform efficient failure analysis.

According to one aspect of the present invention, there is provided a network management method including:
acquiring, by a terminal apparatus that connect to a network, path information from the terminal apparatus to a destination node to store the path information; and
in a failure analysis stage on the network,
receiving the path information from one or a plurality of the terminal apparatus and isolating, by using a learning mode, a suspected failure location on the network, based on the path information received.

According to another aspect of the present invention, there is provided a network system including: at least one terminal apparatus connecting to a network; and an aggregated analysis apparatus connecting to the terminal apparatus.

The terminal apparatus includes: a means that acquires path information from the terminal apparatus to a destination node; a storage part to store the path information; and a means that transmits the path information stored in the storage part to the aggregated analysis apparatus.

The aggregated analysis apparatus includes a means that receivs the path information from one or a plurality of the terminal apparatuses to isolate, by using a learning model, a suspected failure location on the network, based on the path information received.

According to further another aspect of the present invention, there is provided an aggregated analysis apparatus including: a means that receives, from one or a plurality of terminal apparatuses connecting to a network, path information from an individual terminal apparatus to a destination node, the path information acquired by the the individual terminal apparatus; and a means that isolate, by using a learning model, a suspected failure location on the network, based on the path information received.

According to further another aspect of the present invention, there is provided a terminal apparatus connecting to a network, wherein the terminal apparatus includes: a means that acquires path information from the terminal apparatus to a destination node; a storage part that stores the path information; and a means that transmits the path information stored in the storage part to an aggregated analysis apparatus that isolates, by using a learning model, a suspected failure location on the network, based on the path information acquired by one or a plurality of terminal apparatuses.

According to further another aspect of the present invention, there is provided a program causing a computer to execute processing including:
receiving, from one or a plurality of terminal apparatuses connecting to a network, path information from an individual terminal apparatus to a destination node, the pass infromation acquired by the individual terminal apparatus; and
isolating, by using a learning model, a suspected failure location on the network, based on the path information received.

According to further another aspect of the present invention, there is provided a program causing a processor of a terminal apparatus to execute processing including:
acquiring path information to a destination node, the terminal appratus connecting thereto via a network to store the path information in a storage part, and
transmitting the path information stored in the storage part to an aggregated analysis apparatus that isolates, by using a learning model, a suspected failure location on the network, based on the path information acquired by one or a plurality of terminal apparatuses.

According to the present invention, there is provided a computer-readable recording medium storing the above program (non-transitory computer readable recording medium, such as a semiconductor storage (e.g., a RAM (Random Access Memory), a ROM (Read Only Memory), or, an EEPROM (Electrically Erasable and Programmable ROM)), or the like), an HDD (Hard Disk Drive), a CD (Compact Disc), a DVD (Digital Versatile Disc), or the like).

According to the present invention, narrowing down of a suspected failure location on a network is enabled, thus enabling to perform efficient failure analysis.

### BRIEF DESCRIPTION OF THE DRAWINGS

FIG. 1 is a diagram illustrating a system configuration of an example embodiment of the present invention.

FIG. 2 is a diagram schematically illustrating some messages of Ethernet OAM.

FIG. 3 is a diagram illustrating an aggregated analysis apparatus of the example embodiment of the present invention.

FIG. 4 is a diagram illustrating a network configuration of the example embodiment of the present invention.

FIG. 5 is a diagram illustrating a network configuration of the example embodiment of the present invention.

FIG. 6 is a diagram illustrating a configuration of the example embodiment of the present invention.

FIG. 7 is a sequence diagram illustrating an operation in the example embodiment of the present invention.

Example embodiments of the present invention will be described. In one of example embodiments of the present invention,

a terminal apparatus (terminal) obtains:
path information from the terminal apparatus to a destination node thereof;
transmission delay information between the terminal apparatus and the destination node; and
success or failure information in communication with the destination node (e.g., information about the destination node, with which the terminal apparatus fails in communication) and so forth. The terminal apparatus stores the obtained information in a storage part of the terminal apparatus. Then, the terminal apparatus transmits the information stored in the storage part to an aggregated analysis apparatus.

The aggregated analysis apparatus performs, by using, for example, AI, feature extraction from information received from one or a plurality of terminal apparatus to isolate a suspected location of a network failure or the like, thereby enabling to narrow down failure candidates. Thus, it is possible to reduce the number of elements of analysis targets, in failure analysis of a network.

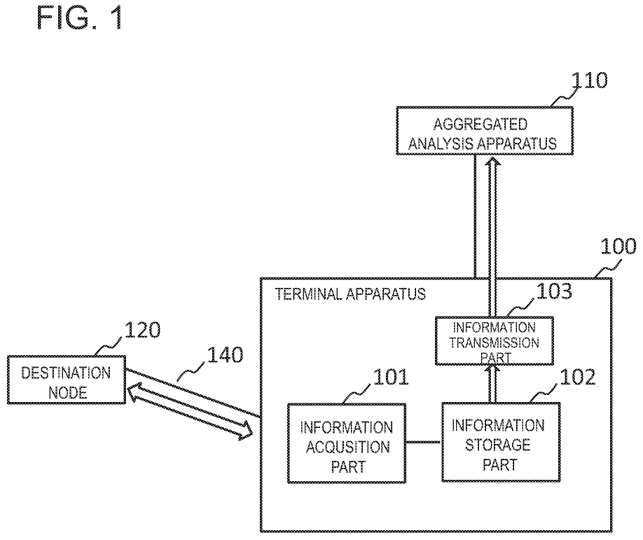

FIG. 1 is a diagram illustrating a system configuration of one example embodiment of the present invention. A terminal apparatus 100 comprises an information acquisition part 101, an information storage part 102, and an information transmission part 103. The terminal apparatus 100 may be a PC (Personal Computer) or an IoT (Internet of Things) device. In FIG. 1, a single terminal apparatus 100 is illustrated for simplification and it is as a matter of course that the system is not limited to such a configuration but may be configured to include a plurality of terminal apparatuses 100 connected to one aggregated analysis apparatus 110.

The destination node 120 may be a server or the like which the terminal apparatus 100 usually accesses, or a specific destination configured in advance in order to isolate of a failure location on a network 140. A plurality of terminal apparatuses 100 may connect to the same destination node 120. Alternatively, a plurality of terminal apparatuses 100 may connect to different destination nodes 120, respectively.

The information acquisition part 101 of the terminal apparatus 100 obtains at least path information on the network 140 from the terminal apparatus 100 to the destination node 120. In addition to the path information about the network 140 between the terminal apparatus 100 and the destination node 120, the information acquisition part 101 may obtain one or both of transmission delay information about the network 140 between the terminal apparatus 100 and the destination node 120 and success or failure information between the terminal apparatus 100 and the destination node 120 (e.g., information about a destination, with which the terminal apparatus 100 has failed in communication).

The information storage part 102 stores, in the storage part (not shown), the path information, the transmission delay information, the success or failure information in communication about the network 140 for each of communication destination nodes 120 obtained by the information acquisition part 101.

The information transmission part 103 transmits the information stored in the information storage part 102 to the aggregated analysis apparatus 110.

The aggregated analysis apparatus 110 analyzes the information (path information, etc.) transmitted from one or a plurality of terminal apparatuses 100, extracts a feature pattern or the like, and executes isolation of a suspected failure location or the like on the network 140. The aggregated analysis apparatus 110 extracts a suspected failure location on the network 140 (e.g., a failure in a port of a NIC (Network Interface Card) of a network appliance, or a failure in a link between two opposing ports, etc.), for the path information transmitted from one or a plurality of the terminal apparatuses 100, based on a learning model (e.g., classification model), or the like, created in advance using machine learning.

The information acquisition part 101 of the terminal apparatus 100 may be configured to obtain the path information, the transmission delay information and so forth to the destination node 120, depending on an instruction from the aggregated analysis apparatus 110, store the obtained information in the information storage part 102 and transmit the stored information to the aggregated analysis apparatus 110. Alternatively, the information acquisition part 101 of the terminal apparatus 100 may be a configured to obtain the path information, the transmission delay information and so forth to the destination node 120, store the obtained information in the information storage part 102, and transmit the stored information to the aggregated analysis apparatus 110, at a predetermined timing or responsive to receiving an instruction from the aggregated analysis apparatus 110. Furthermore, the information acquisition part 101 of the terminal apparatus 100 may be a configured to, when a failure or the like. occurs in communication with the destination node 120, obtain the path information, the transmission delay information and so forth to the destination node 120 and transmit the obtained information to the aggregated analysis apparatus 110.

In FIG. 1, in a case where the terminal apparatus 100 is connected to the destination node 120 via Ethernet (Registered Trademark), the information acquisition part 101 of the terminal apparatus 100 may obtain information, by using, for example, connectivity OAM (monitoring a link state between two non-adjacent appliances) of Ethernet OAM (Operation Administration and Maintenance).

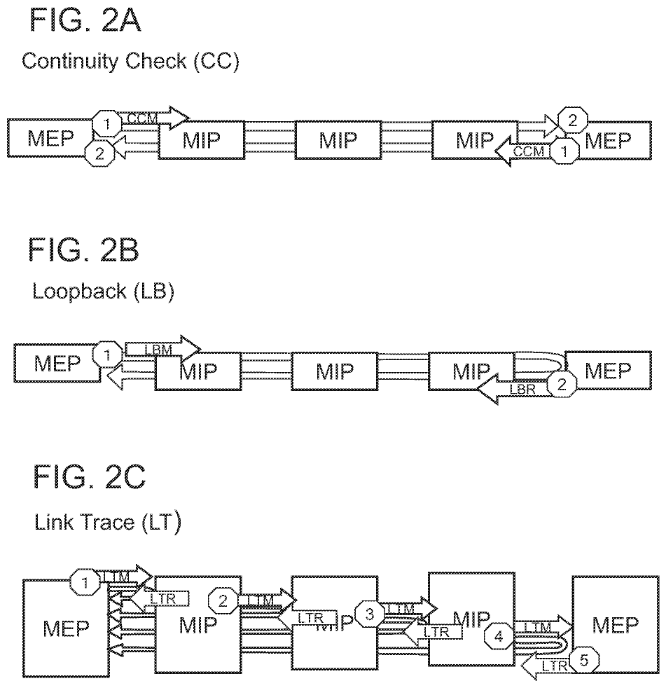

As schematically illustrated in FIG. 2, the connectivity OAM includes Continuity Check, Loopback (corresponding to a ping function on layer 3), and Link Trace (corresponding to a trace route function on layer 3). In the Ethernet OAM, an MEP (MEG (Maintenance Entity Group) End Point) is a maintenance end point which generates and/or terminates an Ethernet OAM frame, and an MIP (MEG Intermediate Point) is an intermediate point of a maintenance entity group (MEG) which relays an Ethernet OAM frame.

CC (Continuity Check) verifies (checks) connectivity between MEPs. An MEP on one end transmits a CCM (Continuity Check Message) toward an MEP on the other end in order to detect communication link failure between the MEPs, and a CCM frame is exchanged between MEP-MEP and between MEP-MIP to perform verification of continuity and isolation of a failure (see FIG. 2A). In FIG. 2A, CCMs are respectively transmitted from a left end MEP to a right end MEP and from the right end MEP to the left end MEP.

LB (Loop Back) transmits, by unicast, an LBM (Loopback Message) from an MEP to an MIP or an MEP which is a destination. On reception of an LBM frame, the MIP or MEP generates an LBR (Loopback Reply) frame and transmits the LBR frame to a transmission source MEP (e.g., the terminal apparatus 100 in FIG. 1). A case where the LBR is not received within a predetermined time period (e.g., 5 seconds as the minimum), indicates “loss of connectivity” (see FIG. 2B).

LT (Link Trace) verifies normality of a path by exchanging a loopback message between an MEP and an MEP, between an MEP and a MIP. When a transmission source MEP (e.g., the terminal apparatus 100 in FIG. 1) transmits a LTM (Link Trace Message) frame to a destination MEP (e.g., the destination node 120 in FIG. 1), the LTM frame is transferred to the destination MEP via MIPs, and all of the MIP/MEPs, through which the LTM frame is passed, return response frames LTR (Link Trace Reply) to a transmission source MEP (see FIG. 2C). A destination MEP which receives in the last, an LTM frame, does not forward the LTM frame further. When transferring the LTM frame, each of MIPs returns information about a reception port and a transfer port for the LTM frame on own apparatus to the LTM transmission source MEP by a response (LTR) frame. The LTM transmission source MEP (e.g., the terminal apparatus 100 in FIG. 1) stores information about the reception port and the transfer port for the LTM included in the response LTR frame received, as path information to a destination.

The information acquisition part 101 may obtain the path information and the transmission delay information of the network 140 to the destination node 120, by using a ping or a traceroute on layer 3. The ping verifies reachability to the destination node 120 by transmitting an echo request (also referred to as a “ping request”) of ICMP (Internet Control Message Protocol) to the destination node 120 and receiving an echo reply transmitted from the destination node 120. In a case of ping, an RTT (Round-Trip Time) and/or a packet loss ratio are calculated based on time until the echo response is returned from the destination node 120 and/or a response ratio. Ping corresponds to LB (Loopback) in Ethernet OAM on layer 2.

Traceroute is a command for verifying path information of a packet up to a destination, which is used to acquire an IP address(es) of a router(s) through which a packet passes from an own node to a destination node, a hop count, and a round trip arrival time to each router. In traceroute, a transmission source transmits a packet by adding 1 to TTL (Time to Live) of an IP (Internet Protocol) header (TTL of a first packet is 1) to obtain path information. TTL represents a living time period of a packet and 1 is subtracted therefrom every time the packet passes through a router. A router, on reception of a packet with a value of TTL being 2 or more, decreases, by 1, the value of TTL of the packet to forward the packet to a next router. A router, on reception of a packet with a value of TTL being 1, discards the packet and returns an ICMP time exceeded packet to the transmission source.

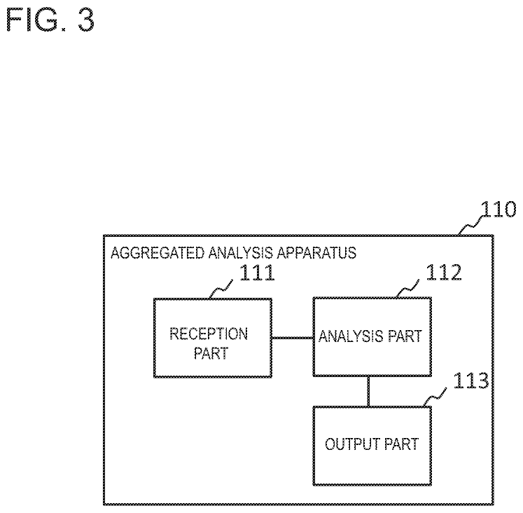

FIG. 3 is a diagram illustrating one example of a configuration of the aggregated analysis apparatus 110. The aggregated analysis apparatus 110 includes a reception part 111 that receives information transmitted from each terminal apparatus 100 (path information, and at least any one of transmission delay information and communication success or failure information with a destination node (information about a destination with which terminal apparatus 100 failed in communication)), an analysis part 112 that analyzes information received from each terminal apparatus 100, extracts a feature value (feature pattern), and executes isolation and identification of a suspected failure location on the network 140, and an output part 113 that outputs the suspected failure location.

In the analysis part 112, a classification model (pattern recognition model) may be created by machine learning, by using, for example, training data (for example, path information from the terminal apparatus to the destination node, transmission delay information, success or failure information in communication with the destination node or processed information thereof) and a ground-truth label (presence/absence, a type of a failure and so forth on a network appliance and a link). On reception, by the reception part 111, of path information, transmission delay information, or success or failure information in communication with a destination node (or processed information thereof) obtained by the terminal apparatus 100, the analysis part 112 may classify the received information, by using the classification model and extract a suspected failure location on the network 140. The learning model (classification model) may be a decision tree of NN (Neural Network) (or deep NN), SVM (Support Vector Machine), Forest Tree, or the like. Parameters or the like in the classification model, such as NN and SVM, may be adjusted by using actual data.

The aggregated analysis apparatus 110 may be installed in, for example, a server of a cloud system or the like (aggregated analysis system) to provide analysis and isolation of a failure location (candidate) on the network 140 as a cloud service.

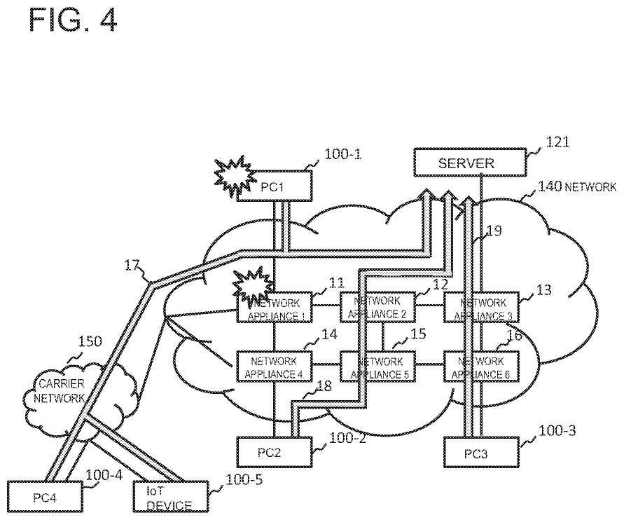

FIG. 4 is a diagram illustrating one example of an example embodiment of the present invention. Terminal apparatuses 100-1 to 100-5 are the terminal apparatus 100 of FIG. 1. A server 121 is a destination in communication by the terminal apparatuses 100-1 to 100-5 (corresponding to the destination node 120 of FIG. 1). 17, 18, 19 indicate communication paths from each terminal apparatus to the server 121. The aggregated analysis apparatus 110 is not shown in FIG. 4.

As a non-limiting example, in FIG. 4, a network 140 may be an enterprise network (enterprise internal LAN), or the like. In this case, each of network appliances 11 to 16 includes a layer 2 switch that forwards at least a layer 2 frame (Ethernet (R) frame). A terminal apparatus 100-4 (PC 4) in FIG. 4 may be corresponded to an external terminal apparatus that accesses the server 121 via the enterprise internal LAN by using a carrier network 150. The enterprise network may, as a matter of course, be configured to a plurality of LANs connected via network appliances (routers). The carrier network 150 is a network of a communication carrier, which includes a radio access network and a core network. The carrier network 150 may be configured to be communicationally connected to the network 140 via the Internet or the like.

The terminal apparatus 100-1, the terminal apparatus 100-4 and the terminal apparatus 100-5 are connected to the server 121 via network appliances 11, 12 and 13 on the network 140 (route 17).

The terminal apparatus 100-2 is connected to the server 121 via network appliances 14, 15, 12 and 13 on the network 140.

The terminal apparatus 100-3 is connected to the server 121 via network appliances 16 and 13 on the network 140.

Reachability to the server 121 may be verified by transmitting a ping request (echo request) in each of the terminal apparatuses 100-1 to 100-5 to the server 121 that corresponds to the destination node 120 of FIG. 1 and determining whether a ping response (echo response) is received from the server 121.

In a case where the network appliances 11 to 16 are a layer 2 switch or the like that is connected via a layer 2 link of Ethernet or the like, the server 121 that corresponds to the destination node 120 of FIG. 1 and the terminal apparatuses 100-1 to 100-5 are adopted as MEPs of FIG. 2 to perform Loopback of Ethernet OAM. That is, the terminal apparatuses 100-1 to 100-5 may respectively transmit LBM of FIG. 2B (a field of a destination MAC address in a frame header is a MAC address of the server 121) and determine presence/absence of reception of a response LBR to verify normality of a path to the server 121.

Alternatively, Link Trace of Ethernet OAM may be performed. The terminal apparatuses 100-1 to 100-5 may respectively transmit LTM of FIG. 2C (a field of a destination MAC address in a frame header is an MAC address of the server 121), receive a response LTR transmitted from each MIP (network appliances arranged on a path to the server 121 which is a destination) to the terminal apparatuses 100-1 to 100-5, and store information, included in the LTR, on reception port and transfer port for the LTM in the network appliances arranged on the path to the server 121, as respective path information from the terminal apparatuses 100-1 to 100-5 to the server 121.

In FIG. 4, a plurality of the terminal apparatuses 100-1 to 100-5 are connected to the same server 121 (the number of the terminal apparatuses: N (N>1,), the number of the server: 1), but a plurality of the terminal apparatuses 100-1 to 100-5 may be, as a matter of course, configured to be connected to different servers.

In FIG. 4, a single terminal apparatus may connect to a plurality of different destination nodes (servers) (the number of the terminal apparatus: 1, and the number of the destination nodes: N) and acquire path information from the single terminal apparatus to a plurality of different destination nodes (servers). In this case, the single terminal apparatus may transmit to the aggregated analysis apparatus 110, information for identifying a destination node with which the terminal apparatus failed in communication (e.g., a MAC address of the destination, or the like) in addition to the path information.

Measurement information obtained by the terminal apparatuses 100-1 to 100-5 is transmitted to the aggregated analysis apparatus 110. The aggregated analysis apparatus 110, performs analysis of the path information collected from each of the terminal apparatuses using a learning model obtained based on machine learning to perform feature extraction. When finding that paths from the terminal apparatuses to the server 121 with which the terminal apparatuses failed in communication, go through a network appliance as a common point, the aggregated analysis apparatus 110 outputs this result (the network appliance as a common point) as an isolation result of a suspected location.

In FIG. 4, the number of the terminal apparatus is five only for the sake of creation of drawing, in a system where a large number of terminal apparatuses are connected to the network 140 (including a large number of network appliances), for example. The number of combination patterns of failure in a physical port of a NIC (Network Interface Card) of a network appliance and patterns of the path information from the terminal apparatuses 100 to the server 121 becomes extremely large (combinatorial explosion). There is such a case where it is difficult to determine which network appliance has a failure from patterns of path information obtained by communication acknowledgement, or the like.

In contrast, the present example embodiment can cope with a large-scale network by, for example, creating a learning model (classification model) based on supervised machine learning, classifying measurement information obtained by the terminal apparatuses 100-1 to 100-5 with the classification model, and extracting a suspected location(s).

According to the present example embodiment, since an aggregated analysis apparatus executes analysis and isolation of a suspected failure location(s) based on information collected in advance and information at a time when a problem occurs, network appliances and communication services to be analyzed can be narrowed down, and resources required for isolation and analysis of the suspected failure location can be suppressed.

The aggregation analysis device 110 may be configured to periodically analyze transmission delay information collected from each terminal apparatus to monitor for presence of a characteristic change therein.

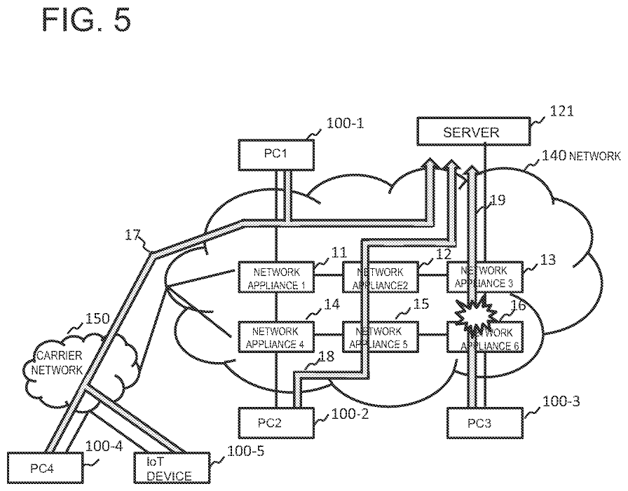

Referring to FIG. 5, a case will be described where a transmission delay from the terminal apparatuses 100-4 to the server 121 becomes large at a certain time point. As the transmission delay (network speed) between each of the terminal apparatuses 100-1 to 100-5 and the server 121, each of the terminal apparatuses 100-1 to 100-5 may perform measurement of RTT by using ping and transmits a measurement result to the aggregated analysis apparatus 110.

When the aggregate analysis unit 110 confirms, with a periodic analysis, that a transmission delay of communication from the terminal apparatus 100-3 to the server 121 has become large, the analysis part 112 performs analysis of path information from each of the terminal apparatuses 100-1 to 100-5 collected up to that time and performs feature extraction. In this case, the analysis part 112 checks that only the communication in question uses a path from the network device 13 to the terminal apparatus 100-3, as a feature of the path from the terminal apparatus 100-3 to the server 121, a transmission delay of which has increased. The output section 113 outputs this result, as an isolation result of a suspected location. Such a configuration makes it possible to detect, for example, a sign of failure of a link (cable) which connects ports of network appliances, a port, a module or the like, and to detect a communication bandwidth crunch of the network 140.

According to the present example embodiment, a terminal apparatus connected to a network stores communication path information and so forth to a communication party (destination node), and aggregates the communication path information and so forth, in the aggregated analysis apparatus 110 so that it is made possible to isolate a failure candidate without effect exerted on a network appliance and a communication service which is used on a communication path between the terminal apparatus and the destination node.

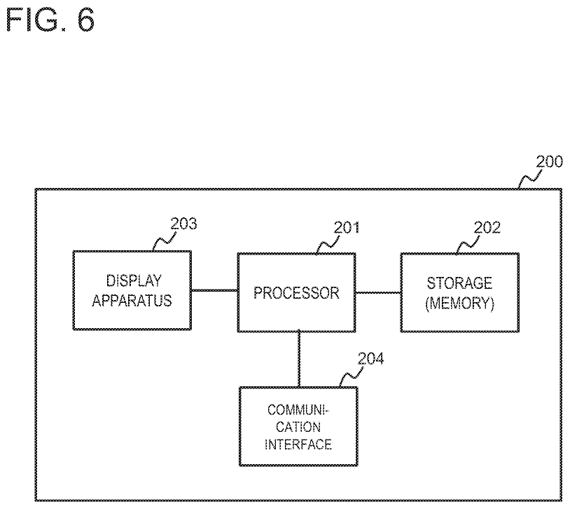

FIG. 6 is a diagram illustrating implementation of the terminal apparatus 100 by a computer apparatus. Referring to FIG. 6, a computer apparatus 200 includes a processor 201, a storage (memory) 202 including a semiconductor memory, an HDD, or the like, a display apparatus 203, and a communication interface 204 such as a NIC or the like. The communication interface 204 communicatively connects to the network 140 (150) and the aggregated analysis apparatus 110. By reading and executing a program (instructions) stored in the storage 202, processing/function of the terminal apparatus 100 in the above-described example embodiment can be implemented.

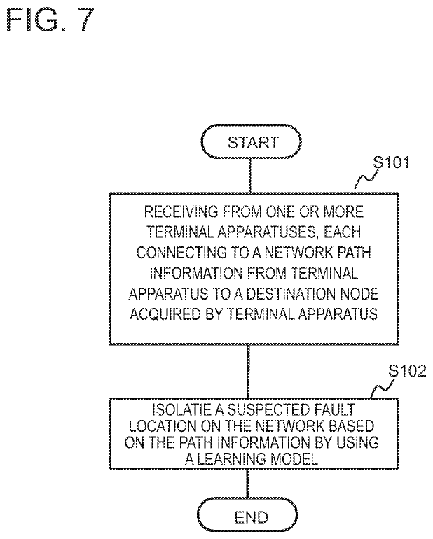

The aggregated analysis apparatus 110 may be also implemented by the computer apparatus 200 in FIG. 6. By reading and executing a program (instructions) stored in the storage 202, processing/function of the aggregated analysis apparatus 110 in the above-described example embodiment can be implemented. FIG. 7 is a diagram illustrating processing by the aggregated analysis apparatus 110. The aggregated analysis apparatus 110 receives, from a plurality of terminal apparatuses 100 connected to a network work 140, path information from each of the terminal apparatuses 100 to the destination node 120 which is obtained by each of the terminal apparatuses 100 (S101). The aggregated analysis apparatus 110 performs isolation of a suspected failure location on the network 140 based on received path information, by using a learning model (S102). In the aggregated analysis apparatus 110, the output part 113 (FIG. 3) may be the display apparatus 203 in FIG. 6.

Each disclosure of the above cited PTLs 1 and 2, and NPL 1 is contemplated to be incorporated herein in its entirety by reference thereto, and to be used as basis or part of the present invention, as necessary. Modifications and adjustments of example embodiments and examples may be made within the bounds of the entire disclosure (including the scope of the claims) of the present invention, and also based on fundamental technological concepts thereof. Furthermore, various combinations and selections of various disclosed elements (including respective elements of the respective appendices, respective elements of the respective example embodiments, respective elements of the respective drawings, and the like) are possible within the scope of the claims of the present invention. That is, the present invention clearly includes every type of transformation and modification that a person skilled in the art can realize according to the entire disclosure including the scope of the claims and to technological concepts thereof. Further, each of the disclosures in the above-cited documents may be used, if necessary, as part of the disclosure of the present invention in accordance with the gist of the present invention, in part or as a whole, in combination with the descriptions in the present disclosure, and shall be deemed to be included in the disclosure of the present application.

### REFERENCE SIGNS LIST

11 to 16 network appliances

100, 100-1 to 100-5 terminal apparatuses

101 information acquisition part

102 information storage part

103 information transmission part

110 aggregated analysis apparatus

111 reception part

112 analysis part

113 output part

120 destination node

121 server

140 network

150 carrier network

200 computer apparatus

201 processor

202 storage (memory)

203 display apparatus

204 communication interface

What is claimed is:

1. A network management method comprising:
acquiring, by a terminal apparatus that connect to a network, path information from the terminal apparatus to a destination node to store the path information; and
performing failure analysis stage on the network, wherein
the performing failure analysis comprises:
receiving the path information from one or a plurality of the terminal apparatus; and
isolating, by using a learning mode, a suspected failure location on the network, based on the path information received.

2. The network management method according to claim 1, comprising:
the terminal apparatus further acquiring at least one of:
transmission delay information between the terminal apparatus and the destination node; and
success or failure information on communication with the destination node; and
in performing the failure analysis on the network,
receiving, from the terminal apparatus, in addition to the path information, at least one of the transmission delay information and the success or failure information on communication with the destination node and isolating the suspected failure location on the network, based on information received in addition to the path information, by using the learning model.

3. (canceled)

4. A aggregated analysis apparatus comprising:
a processor;
a memory storing program instructions executabel by the processor; and
a recever that receives, from one or a plurality of terminal apparatuses connecting to a network, path information from an individual terminal apparatus to a destination node, the path information acquired by the the individual terminal apparatus,
wherein that the processor is configured to isolate, by using a learning model, a suspected failure location on the network, based on the path information received.

5. The aggregated analysis apparatus according to claim 4, wherein the receiver is configured to
receive, in addition to the path information from the terminal apparatus to the destination node,
at least one of
transmission delay information between the terminal apparatus to the destination node, and
success or failure information in communication with the destination node, and wherein
the processor is configured to isolate the suspected failure location on the network, based on the information received in addition to the path information, by using the learning model.

6-7. (canceled)

8. A non-transitory computer-readable medium storing therein a program causing a computer to execute processing comprising:
receiving, from one or a plurality of terminal apparatuses connecting to a network, path information from an individual terminal apparatus to a destination node, the pass infromation acquired by the individual terminal apparatus; and
isolating, by using a learning model, a suspected failure location on the network, based on the path information received.

9. (canceled)

10. The network management method according to claim 1, comprising:
sending to the network, by the terminal apparatus, a frame or a packt for ckecking a connectivity and/or reachability to the destination node to acqure the path information to the destination node.

11. The network management method according to claim 1, comprising:
sending to a node in a path between the terminal and the destination node, by the terminal apparatus, a packt for loopback to acqure round-trip time or packet loss ratio in the path.

12. The network management method according to claim 1, comprising:
in performing a failure analysis,
when finding that paths from the terminal apparatuses to the destination node, with which the terminal apparatuses failed in communication, go through a network appliance in the network as a common point, outputting the finding result as an isolation result of a suspected location.

13. The aggregated analysis apparatus according to claim 4, wherein the receiver is configured to
receive, in addition to the path information from the terminal apparatus to the destination node,
at least one of
success or failure information in communication with the destination node, and wherein
the processor is configured to
when finding that paths from the terminal apparatuses to the destination node, with which the terminal apparatuses failed in communication, go through a network appliance in the network as a common point, output the finding result as an isolation result of a suspected location.

14. The aggregated analysis apparatus according to claim 4, wherein the receiver is further configured to
receive periodically, from the terminal appratus, the transmission delay information between the terminal apparatus to the destination node, and wherein
the processor is configured to:
monitor for presence of a characteristic change in the transmission delay; and
isolate the suspected failure location on the network, based on the characteristic change in the transmission delay.
